(19) United States
(12) Patent Application Publication
(10) Pub. No.: US 2001/0043388 A1
(43) Pub. Date: Nov. 22, 2001

(54) High order mode erbium-doped fiber amplifier

(76) Inventors: Yochay Danziger, Rishon Le Zion (IL); David Menashe, Kiryat Ono (IL); Eran Herman, Rishon Le Zion (IL)

Correspondence Address: Edward Langer, c/o Landon & Stark Associates, One Crystal Park, Suite 210, 2011 Crystal Drive, Arlington, VA, 22202, US

(21) Appl. No.: 09/793,540

(22) Filed: Feb. 27, 2001

Related U.S. Application Data
(60) Provisional application No. 60/185,884, filed on Feb. 29, 2000.

(51) Int. Cl. H01S 3/00

(52) U.S. Cl. 359/341.3

(57) ABSTRACT

An Erbium-doped fiber amplifier wherein the signal and/or the laser pump source are introduced into the erbium-doped fiber in a high order spatial mode. A mode transformer is utilized to transform the optical signal or the laser pump source to a second spatial mode. A coupler and erbium-doped profile are also described.

### CROSS-REFERENCE TO RELATED APPLICATIONS

The present application claims priority to provisional U.S. patent application Ser No. 60/185,884 filed Feb. 29, 200, and incorporates by reference U.S. patent application Ser. No. 09/248,969 filed Feb. 12, 1999.

### FIELD OF THE INVENTION

The invention relates generally to optical communication systems and, more specifically, to optical fiber amplifiers.

### BACKGROUND OF INVENTION

Optical pulses transmitted through an optical waveguide such as an optical fiber, experience attenuation in the fiber. Over the long link distances found in some networks, the signal requires amplification at points along the network in order to ensure that it is readable at the receiver. Erbium-doped Fiber Amplifiers (EDFA) were designed to solve this problem without requiring the conversion of the optical signal to an electronic signal for re-amplification. EDFA technology is well developed. Typical transmission systems utilizing EDFA technology include single mode fibers (SMFs), in which an optical signal propagates in the LP₀₁ fundamental mode. As the optical signal propagates in the fiber, it experiences attenuation. Eventually, the signal amplitude degrades to a point in which the signal will no longer be distinguishable from noise by a receiver. Normally, before substantial signal degradation occurs some form of signal re-amplification or regeneration occurs.

One type of re-amplification includes the use of EDFAs which amplify the signal as it traverses the transmission system. An EDFA comprises a fiber which has a core that is doped with erbium ions and a laser pump. The EDFA is coupled to the SMF which is transmitting the optical signal in the LP₀₁ mode. When excited by the energy of the laser pump, the erbium ions in the core of the erbium-doped fiber act to amplify the optical signal. It is important to note that having a minimal amount of erbium ions in the rest state improves the noise figure. The amplification process can be understood with reference to FIG. 2.

FIG. 2 illustrates the energy levels of the erbium ions in an erbium-doped fiber which are relevant to the function of the EDFA. State 40 is the ground state. When the light pump energy 24 is incident on an erbium ion, its energy is raised to an intermediate short lived state 44, from which the ions descend non-radiatively into an excited metastable state 42 (with a typical lifetime of 10 milliseconds in state 44). The fraction of ions in the intermediate state 44 is typically denoted as N₃, the fraction in the excited metastable state 42 is denoted as N₂, and the fraction in the ground state 40 is denoted as N₁. During the steady state operation of an EDFA, N₃<<1 due to the short lifeline of the intermediate state, and thus as a first approximation, N₁+N₂=1. When the signal to be amplified passes through the fiber, stimulated emission of photons occurs from the metastable state 42 as the atoms return to the ground state N₁. This stimulated emission of photons amplifies the signal field.

Because erbium ions in the ground state cause attenuation of the signal (through absorption), and erbium ions in the metastable state cause amplification of the signal through stimulated emission, in order to amplify, N₂ must be greater than N₁.

Further, the noise figure (NF) of the EDFA, defined as the ratio of the input signal to noise ratio (SNR) to the output SNR is minimum when N₂ is much greater than N₁ (i.e. when N₂ is close to one all along the fiber).

The value of N₂ at any point along the fiber is affected by the local intensity of the pump. The intensity decays along the length of the fiber and is typically lower at the sides of the cross section of the fiber due to the mode distribution of the pump. N₂ is also a function of the average pump intensity Γ_{avg} which couples with the erbium dopant ions. Average intensity in turn is affected by the pump power, Pₚᵤₘₚ and the degree of overlap of the spatial mode of the pump energy in the fiber with the spatial distribution of erbium ions.

The degree of overlap of the pump energy with the erbium ions is characterized by the overlap integral, Γₚᵤₘₚ. Other factors affecting the value of N₂ along the fiber include: the concentration ρ of the erbium dopant in the fiber; the cross section ρ of the interaction between the erbium ions and the photons of the pump and the lifetime τ of the ions in the metastable state.

The degree of overlap of the spatial mode of the sign in the fiber with the spatial distribution of erbium ions is characterized by the overlap integral Γ_{signal}. All other things being equal, increasing Γ_{signal} will increase the gain per unit length of erbium-doped fiber, since more of the signal overlaps the excited metastable state ions.

Light energy propagating in an optical fiber can exhibit any one of a number of different modes. Each mode exhibits a specific shape which is dependent among other things on the geometry and characteristics of the fiber. The fundamental mode, which is supported in all optical fibers transmitting light is also known as the LP₀₁ mode, and is typically a gaussian shape. Other higher order modes may exist, and are typically described utilizing two suffixes with the first number indicating the angular symmetry of the mode, and the second number indicating the number of radial positions where the node power is zero. For example the LP₀₂ mode describes a circularly symmetric mode with two peaks, one at the center and one radially displaced from the center, and between the peaks a single radial position with zero power. Different fibers with different cross section profiles may exhibit different shapes for like numbered modes.

Therefore, it would be desirable to provide an EDFA utilizing high order spatial modes, to achieve an improved gain profile.

### SUMMARY OF THE INVENTION

Accordingly, it is a principal object of the present invention to overcome the problems associated with prior art optical communication systems, and provide an improved EDFA utilizing higher order modes. In one embodiment, less pump energy is required for the same amplification achieved in prior art designs. Another advantage expected is lower noise due to a higher N₂ than is experienced in prior art designs. Still another advantage is increased gain per unit length of EDF.

The invention provides a rare-earth doped fiber amplifier for amplifying an optical input signal having a first spatial mode

In one embodiments the apparatus includes a laser pump for generating light energy having a second spatial mode. The apparatus also includes an optical fiber which includes a rare-earth dopant in optical communication with the laser pump, the optical fiber being designed to support the second spatial mode. The optical input signal is amplified in the optical fiber by stimulated emission from the Erbium ions, which were excited by the laser pump.

In another embodiment, the apparatus further includes an optical coupler having a first input port for receiving the optical input signal, a second input port in optical communication with the laser pump, and an output port for coupling optical signals from the first and second input ports and outputting the coupled signals.

In another embodiment, the first spatial mode is the LP₀₁ spatial mode. In yet another embodiment, the second spatial mode is the LP₀₂ spatial mode.

In another embodiment the optical signal is received in a first spatial mode, and includes a spatial mode converter for converting the optical signal to a third spatial mode. The apparatus further includes a laser pump for generating high energy and a mode converter for converting the light energy into a second spatial mode. The apparatus also includes an optical fiber which includes a rare-earth dopant in optical communication with the spatial mode converter, the optical fiber being designed to support the second spatial mode. The optical input signal is amplified in the optical fiber by stimulated emission from the Erbium ions, which were excited by the laser pump.

The invention also provides a method for amplifying an optical input signal. The method includes the steps of receiving light pump energy having a second spatial mode, and transferring the light pump energy to the optical input signal to generate an amplified optical signal.

The invention further provides a coupler having at least one phase element and either a Faraday rotator or a dichroic filter for coupling light having different wavelengths, and at least one of which is in a high order mode.

The invention further provides an amplifying optical fiber including a core region doped with a rare-earth dopant, and a cladding surrounding the core, the cladding including at least one refractive index step and wherein the amplifying optical fiber supports a high order spatial mode. In one embodiment, the rare-earth dopant is erbium. In another embodiment, the high order spatial mode is the LP₀₂ mode.

Additional features and advantages of the invention will become apparent from the following drawings and description.

### BRIEF DESCRIPTION OF THE DRAWINGS

For a better understanding of the invention with regard to the embodiments thereof, reference is made to the accompanying drawing, in which like numerals designate corresponding elements or sections throughout, and in which:

FIG. 1a illustrates a communication system utilizing an EDFA known to the prior art;

FIG. 1b illustrates another communication system utilizing an FDFA known to the prior art;

FIG. 2 illustrates various energy states of erbium ions known to the prior art;

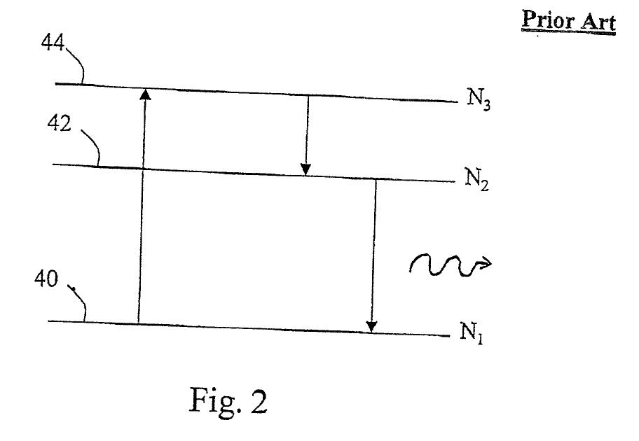

FIG. 3a illustrates the refractive index profile of an EDFA known to the prior art;

FIG. 3b illustrates the mode intensity of the signal as a function of radius of the fiber for the fiber amplifier shown in FIG. 3a; FIG. 4a illustrates an embodiment of a communication system utilizing an EDFA according to the present invention;

FIG. 4b illustrates another embodiment of a communication system utilizing an FDFA according to the present invention;

FIG. 5a illustrates the refractive index profile of an erbium-doped fiber according to the present invention;

FIG. 5b illustrates the mode intensity of the signal as a function of radial distance for the fiber amplifier shown in FIG. 5a;

FIG. 6a illustrates a coupler utilizing a dichroic filter according to the present invention;

FIG. 6b illustrates a coupler utilizing a Faraday rotator according to the present invention;

FIG. 6c illustrates another embodiment of a coupler utilizing a Faraday rotator according to the present invention, and

FIG. 6d illustrates a coupler utilizing a polished fiber coupler according to the present invention.

### DETAILED DESCRIPTION OF THE PREFERRED EMBODIMENTS

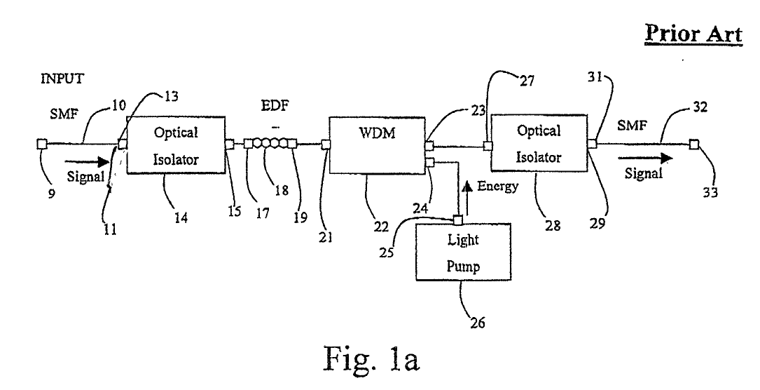

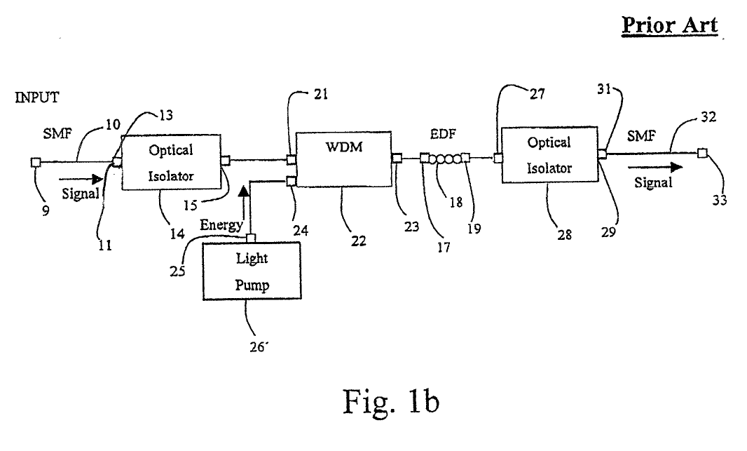

FIG. 1a shows a prior art EDFA system including an erbium-doped fiber (EDF) which utilizes a reverse pumping apparatus. The system consists of a single mode fiber (SMF) 10 having an input 9 and an output 11, coupled to the input port 13 of an optical isolator 14. The output port 15 of the optical isolator 14 is coupled to the input 17 of EDF 18. The output 19 of EDF 18 is coupled to one input port 21 of wavelength division multiplexer (WDM) 22. WDM 22 has two input ports 21 and 24. Input port 24 of WDM 22 is coupled to output port 25 of light pump 26. Output port 23 of WDM 22 is coupled to the input port 27 of optical isolator 28. Output port 29 of optical isolator 28 is coupled to the input 31 of SMF 32.

In operation, an optical signal having energy in the LP₀₁ mode propagates in SMF 10. The optical signal then propagates through optical isolator 14, which prevents any signal in the system from propagating back through SMF 10. The signal then enters EDF 18 where it will be amplified. Light pump 26 generates light pump energy which exits light pump 26 through output port 25. The light pump energy enters WDM 22 through input port 24, where it is coupled to EDF 18.

As previously discussed, optical isolator 14 functions to prevent the flow of Amplified Spontaneous Emission (ASE) generated in the EDF 18, and any light pump energy generated in light pump 26, from traveling back down input fiber 10. Light pump 26 outputs energy in a wavelength band which is compatible to the absorption spectrum of the erbium ions, typically either at around 980 nm or 1480 nm. The optical signal is then amplified using EDF 18 by transferring light pump energy from light pump 26 to the input optical signal. The amplified signal is then coupled using WDM 22 and the optical isolator 26, which prevents backscattering and optical noise at the output of the system from entering the EDF 18, to the output 33 of SMF 32. The amplified signal appears as an output signal in the output port 29 of optical isolator 29 of the apparatus and propagates in SMF 32.

An alternative embodiment is shown in FIG. 1b, in which forward pumping is used, with light pump 26′ operating to pump the energy in a forward direction. In this embodiment, light pump 26′ outputs light pump energy into WDM 22 where it is coupled with the optical input signal. The in combined signal is then output from WDM 22 into EDF 18 where it is amplified.

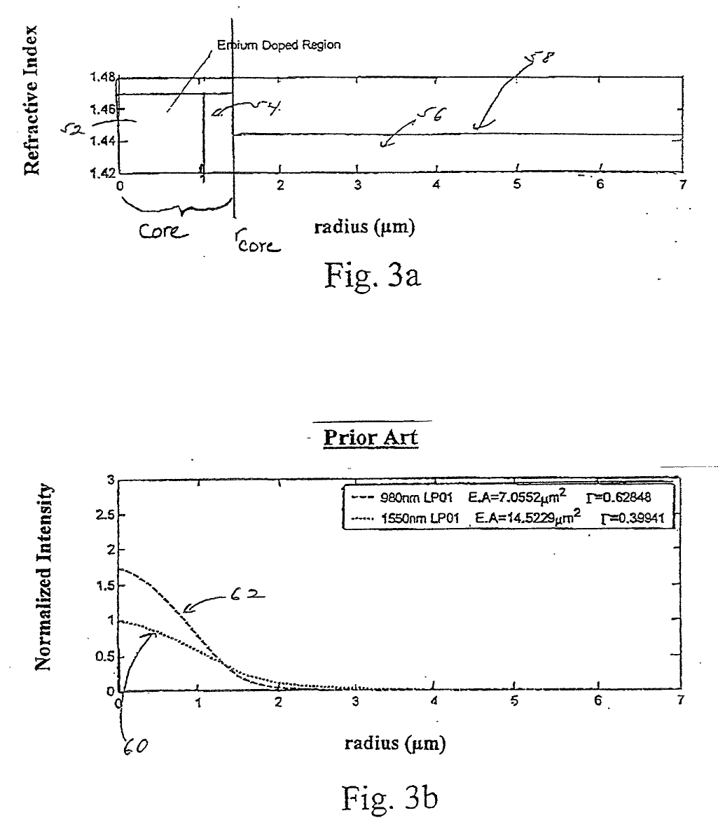

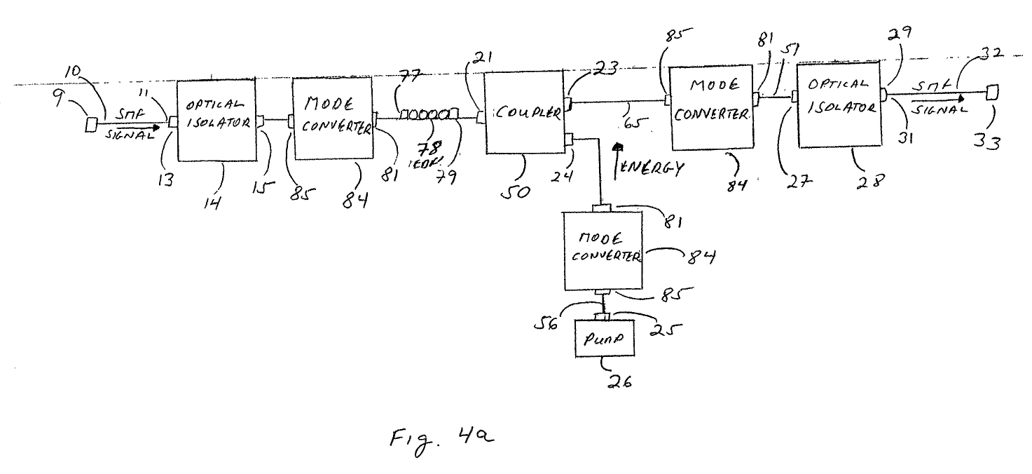

FIG. 3a, depicts the radial refractive index profile of a typical prior art EDF used in an EDFA. The x-axis depicts radial distance in microns, and the y-axis depicts the refractive index at the operative 1550 nm wavelength. The fiber exhibits a core region (r_{core}) containing two sub regions 52 and 54, and a cladding region 56 with refractive index 58. Core sub-region 52 contains the erbium dopant, while core sub-region 54 contains little if any erbium dopant. In typical prior art systems such a fiber has an extremely small core, typically 1.4 microns in radius, of which the erbium-doped section 52 is approximately 1.0 microns in radius. The small core is required to size N₂ which in turn maximizes the amplification for a given pump power. In the prior art design shown, the core is designed to have a refractive index of approximately 1.47 versus a cladding index of 1.444, and a radius (r_{core}) of approximately 1.4 microns; with the erbium-doped region 52 having a radius of approximately 1.0 microns.

FIG. 3b depicts the pump energy 62 and signal energy 60 in a fiber which propagates the basic or LP₀₁ mode. The x-axis depicts the radial distance in microns, and the y-axis depicts the normalized intensity in units of 1/micron². Due to the small core diameter, this is the only mode that exists in the fiber at these wavelengths. The effective fiber cross-sectional area for the pump energy 62, at a wavelength of 980 nm, is 7.0552 μm², with a maximum normalized intensity of approximately 1.75 μm⁻². The overlap integral Γₚᵤₘₚ of the fiber is 0.62848. The signal 60, at a nominal wavelength of 1550 nm, has an effective area of 14.5229 μm², which is quite small compared to a typical single mode fiber which has an effective area between 50-80 μm². The small core diameter is necessary for maximizing I_{avg}.

The invention will be described with the pump energy converted to a high order mode, specifically the LP₀₂ mode, however this is not intended to be limiting in any way. Other higher order modes may be utilized to achieve the same goals, as will be apparent to one skilled in the art.

Similarly, the invention will be described with the optical signal converted to a high order mode, specifically the LP₀₂ mode, however this is not intended to be limiting in any way. In another embodiment the optical signal may be converted to a different high order mode than the pump energy, and in yet another embodiment the optical signal may be input in the fundamental mode. In another embodiment the pump energy may be input in the fundamental mode and the signal may be in a high order mode, in an exemplary embodiment the LP₀₂ mode, all without exceeding the scope of the invention.

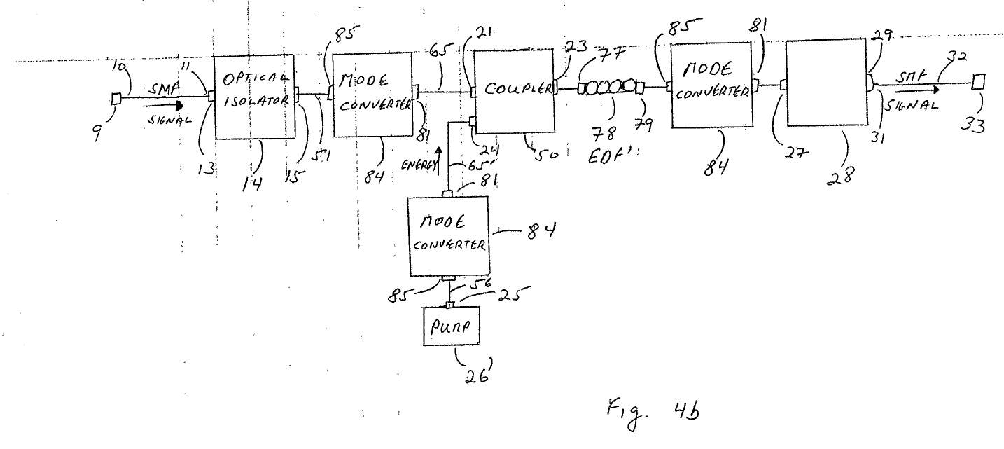

FIG. 4a depicts an embodiment of an EDFA designed in accordance with the principles of the invention and including a high order mode EDF 78 (EDF′), which utilizes a reverse pumping apparatus. The system consists of a single mode fiber (SMF) 10 having an input 9 and an output 11, coupled to the input port 13 of an optical isolator 14. The output port 15 of the optical isolator 14 is coupled to the input 85 of mode converter 84, and output port 81 of mode converter 84 is connected to the input port 77 of high order mode EDF′ 78. The output 79 of EDF′ 78 is coupled to port 21 of coupler 50.

Coupler 50 has three ports 21, 23 and 24. Port 23 functions as an output port, port 21 functions as both an input and output port, and port 24 functions as an input port. Port 24 of coupler 50 is coupled to output port 81 of second mode converter 84. The output port 25 of light pump 26 is coupled to the input port 85 of second mode converter 84 through fiber 56. Output port 23 of coupler 50 is coupled through fiber 65 to the input port 85 of the third mode converter 84. The output 81 of third mode converter 84 is connected to through fiber 51 to input 27 of optical isolator 28. Output port 29 of optical isolator 28 is coupled to the input 31 of SMF 32.

In operation, an optical signal having energy in the LP₀₁ mode propagates in SMF 10. The optical signal is typically in the wavelength range of 1550 nm, other wavelengths may be utilized without exceeding the scope of the invention. The optical signal than propagates through optical isolator 14, which prevents any signal in the system from propagating back through SMF 10. The signal then enters first mode converter 84, which is an exemplary embodiment may be a tranverse mode transformer as described in copending U.S. patent application Ser. No. 09/248,969 whose contents are incorporated by references. Other spatial mode converters or transformers may be utilized; including longitudinal mode converters and those described in U.S. Pat. No. 4,974,931 and U.S. Pat. No. 5,261,016 whose contents are incorporated by reference without exceeding the scope of the invention.

In another embodiment (not shown) the input signal is in a high order mode and no mode transformation is required. The output of mode converter 84 appears at output port 81 and consists of the signal substantially in a single high order mode. In an exemplary embodiment, the high order mode is the LP₀₂ mode. Upon exiting mode converter 84 the optical signal in the high order mode enters EDF′ 78 where it will be amplified.

Light pump 26 generates light pump energy which exits light pump 26 through output 25. The light pump energy then enters second mode converter 84, where the light pump energy from light pump 26 is mode converted from the LP₀₁ spatial mode to a higher order spatial mode. In another exemplary embodiment, the higher order spatial mode is the LP₀₂ mode.

Other modes may be utilized as well, and there is no requirement that the mode of the signal match the mode of the pump energy. The actual mode to be chosen depends on the desired overlap integral, pump energy and desired gain as well as the characteristic profile of the EDF. The output port 81 of mode converter 84 is coupled to input port 24 of coupler 50, which has been designed to handle high order modes and will be further described herein below.

In an alternative embodiment, pump energy for light pump 26 is in the desired high order mode, and second mode converter 84 is not required. In this alternative embodiment (not shown) output 25 of pump 26 is connected directly to input 24 of coupler 50.

The light pump energy in the LP₀₂ mode is coupled to EDF′ 78 using coupler 50 through port 21. As previously discussed, optical isolator 14 functions to prevent the flow of ASE generated in the EDF′ 78, and any light pump energy generated m light pump 26′, from traveling back down input fiber 10. Light pump 26 outputs energy in a wavelength band which is compatible with the absorption spectrum of the erbium ions, typically either at around 980 nm or 1480 nm. The optical signal is then amplified using EDF′ 78 by transferring light pump energy from light pump 26 to the input optical signal.

The amplified signal is then coupled using coupler 50 entering through port 21 and exiting through port 23 where it is connected to third mode converter 84, which reconverts the signal from the single high order mode to the LP₀₁ mode. The signal in the LP₀₁ mode exits the third mode converter 84 at port 81 and enters optical isolator 28 at port 27, which prevents backscattering and optical noise at the output of the system from entering the EDF′ 78. The amplified signal in the LP₀₁ mode appears at the output 29 of optical isolator 28 where it is connected through input 31 to SMF 32 and propagates through SMF 32 to the output 33.

Alternative embodiment is shown in FIG. 4b, in which forward pumping is used with light pump 26′ operating to pump the energy in a forward direction. The system consists of a single mode fiber (SMF) 10 having an input 9 and an output 11 coupled to the input port 13 of an optical isolator 14. The output port 15 of the optical isolator 14 is coupled through fiber 51 to the input 85 of first mode converter 84.

In another embodiment (not shown) the input signal is in a high order mode and no mode transformation is required. Output port 81 of first mode converter 84 is connected through fiber 65 to input port 2 of coupler 50. Coupler 50 has three ports 21, 23 and 24. Port 23 functions as an output port, port 21 and port 24 functions as an input port. Light pump 26 generates light energy which appears at output port 25 of light pump 26, and is coupled through fiber 56 to the input port 85 of second mode converter 84. Output port 81 of second mode converter 84 is connected through fiber 65′ to the second input port 24 of coupler 50. Port 23 of coupler 50 functions as an output port and is connected to the input port 77 of high order mode EDF′ 78. The output 79′ of EDF 78 is coupled to the input port 85 of the third mode converter 94 and output 81 of third mode converter 84 is connected to input 27 of optical isolator 28. Output port 29 of optical isolator 28 is coupled to the input 31 of SMF 32.

In operation the signal is amplified in the same manner as discussed in connection with the configuration of FIG. 4a and FIG. 1b.

While the above has been described utilizing a mode converter which is separate from said pump 26, and 26′ respectively, in another embodiment the units are combined and the output of pump 26 and 26′ respectively are in the desired high order spatial mode.

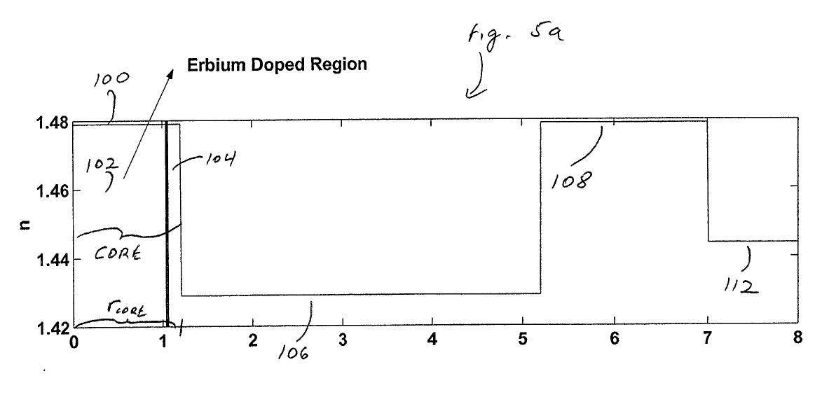

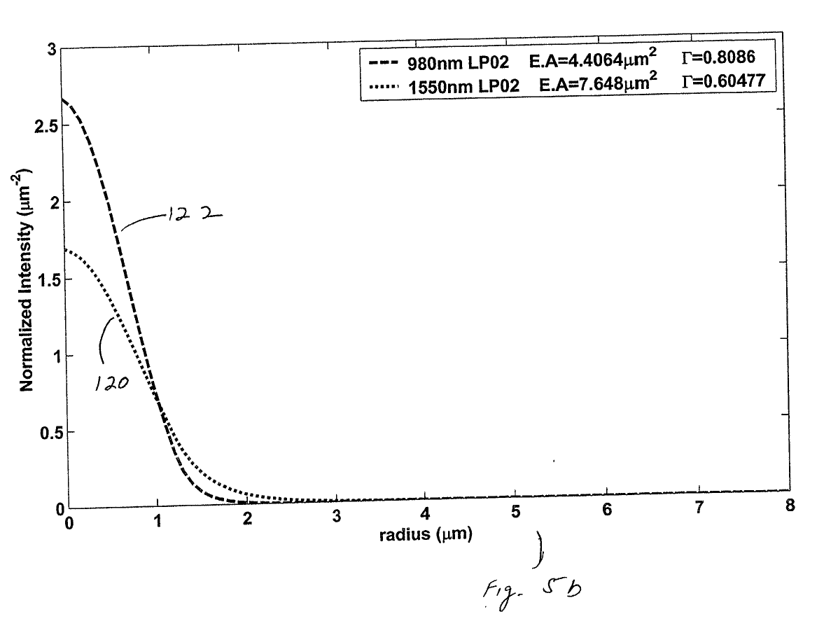

FIG. 5a depicts a refractive index profile of an EDF′ 78 designed according to the principles of the invention. The x-axis depicts the radial position and the y-axis depicts the refractive index at the operative wavelength of 1550 nm in units of 1/micron². FIG. 5a illustrates a core region (r_{core}) with reactive index 100, in the exemplary embodiment 1.479 versus the cladding of 1.444. The radial width of the total core region is 1.2 microns, consisting of sub-region 102 containing an erbium dopant and sub-region 104 which substantially does not contain erbium. Adjacent to area 104 is a depressed area 106, which has a refractive index of 1.429 indicating a reduction of refractive index of 0.015 as compared to the cladding. The radial width of region 106 is 4 microns.

Adjacent to region 106 is a second ridge area 108 with substantially the same refractive index as in areas 102 and 104, which exhibits a radial width of 1.8 microns. The refractive index profile of the fiber is designed to maximize the intensity of the LP₀₂ pump mode at the center of the fiber. Sub-region 102 of the core area 100 is doped with erbium and in only embodiment, has an erbium-doped sub-region radius of 1.05 μm. The profile is designed to compress the pump energy which is in the LP₀₂ mode. By maximizing the pump intensity at the center of the core, Γₚᵤₘₚ is maximized for a given erbium distribution.

FIG. 5b depicts the pump energy 122 optical signal 120 in the fiber of FIG. 5a. The x-axis depicts the radial position in micron, and the y-axis depicts the normalized intensity in units of 1/micron². The graph is shown with the same scale as the graph of FIG. 3b. The light pump energy 122 and the signal 12 are both in the LP₀₂ mode. The normalized intensity of the pump power has a maximum value of approximately 2.6 μm⁻², and an overlap integral Γₚᵤₘₚ of 0.8086 in the LP₀₂ mode, which compares favorably with the Γₚᵤₘₚ of 0.62848 of the prior art EDFA shown in FIG. 3b. The pump power is confined by the refractive index profile to the erbium-doped region which causes N₂ to be close to one. As mentioned above, maintaining N₂ as close to one as possible minimizes the noise.

In addition, due to the concentration of the power in the central core area, less pump power can be utilized to achieve the sane amplification. A further advantage is that an increase in gain is achieved per unit length to EDF. The signal which is in the LP₀₂ mode and is shown as curve 120, exhibits an Γ_{signal} of 0.60477, which is significantly higher that the Γ_{signal} of 0.3994 of the prior art FDFA shown in FIG. 3b. The curves 120 and 122 are both shown in the LP₀₂ mode, which can be verified despite their overall appearance by computer simulation. Other high order modes are supported by the fiber of FIG. 5a, as shown in Table I. The overlap integrals of the other nodes are however quite small, and thus any portion of the signal appearing in the undesired modes is not significantly amplified.

TABLE I

| Mode | 980 nm | 1550 nm |
|---|---|---|
| LP01 | 6.2326e-008 | 6.7668e-005 |
| LP11 | 2.7018e-009 | 2.4193e-006 |
| LP21 | 3.4192e-010 | 1.9552e-007 |
| LP31 | 4.3615e-011 | 1.5325e-008 |
| LP14 | 5.0462e-012 | 1.0884e-009 |
| LP15 | 5.2391e-013 | 6.9615e-011 |

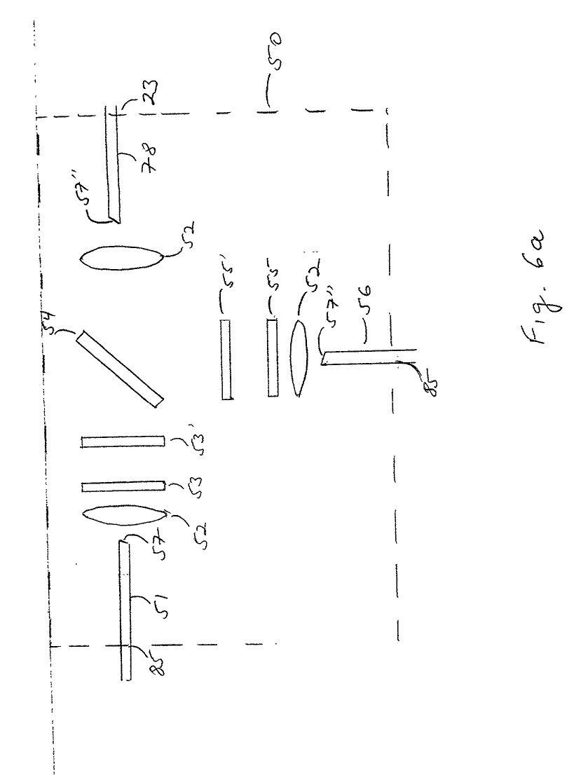

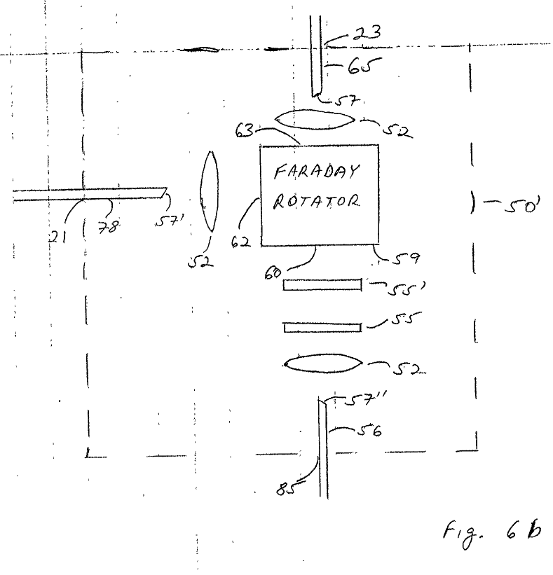

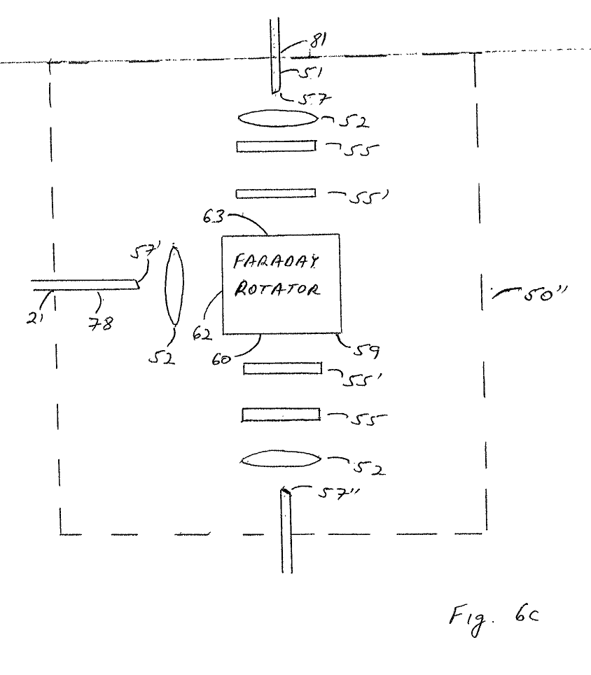

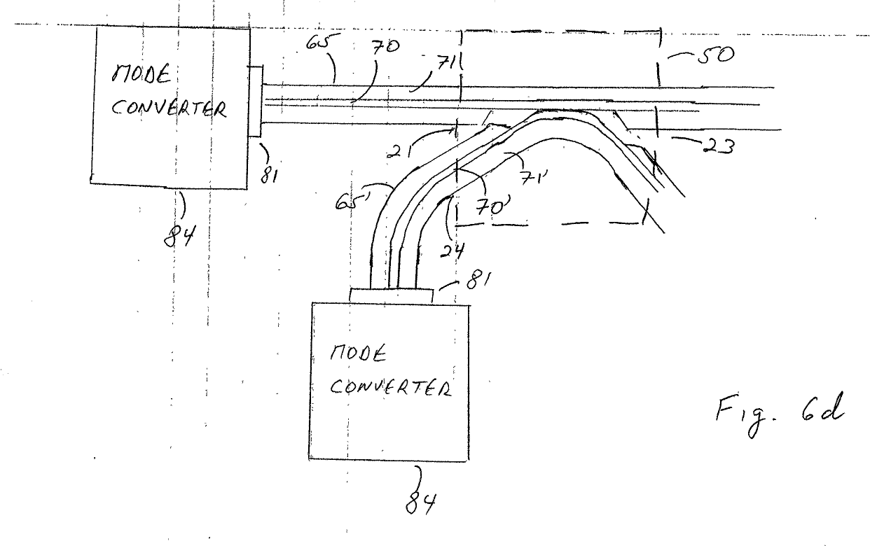

FIG. 6a illustrates one embodiment of coupler 50 combined with first and second mode converters 84 of FIG. 4b, and comprises single mode fiber 51, cut with end face 57, collimating lens 52, phase element 53, dichroic filter 54, pump single mode fiber 56, phase elements 54 and 54′ and EDF′ 78. Single mode fiber 51 propagates the signal in the LP₀₁ mode received at input port 85. The end face 57 of fiber 51 is cut at an angle, in order to minimize back reflection. In an exemplary example the end face 57 is polished at an angle of eight degrees. The output of fiber 51 is collimated by lens 52 and is then reshaped by phase element 53 and optional phase element 53′ so that the resulting wavefront will be of the proper shape to enter EDF′ 78 in the LP₀₂ mode.

A mode transformer utilizing phase elements is described in copending U.S. patent application Ser. No. 09/248,969. The signal propagating in single mode fiber 51 is typically in the wavelength of 1550 nanometers, and dichroic filter 54 is designed to pass light energy of that wavelength, and to act as a mirror for the pump energy as will be described below. Lens 52 focuses the light energy exiting dichroic filter 54 onto the end face 57″ of EDF′ 78. Fiber 56 propagates the laser pump energy in a different wavelength from that of the signal, in an exemplary embodiment 980 nm.

The light is typically in the LP₀₁ or fundamental mode, since fiber 56 is a single mode fiber, and the end of fiber 56 functions as input 85 of second mode converter 84. Pump energy leaves end face 57″ of fiber 56 and is collimated by lens 52. Collimated pump energy exiting lens 52 is transformed by phase elements 55 and 55′ to the wavefront of a specific high order mode, in an exemplary embodiment the LP₀₂ mode. The phase elements are designed so that the wavefront matches the shape of the mode as it is supported in EDF′ 78. Other modes may be utilized without exceeding the scope of the invention.

In another embodiment a single phase element 55 is utilized. The output of phase elements 55 and 55′ is received by dichroic filter 54, which acts as a mirror at the pump wavelength, and is placed at the appropriate angle to reflect the energy in a line with the signal energy passing through from fiber 51. Lens 52 focuses the pump energy in the LP₀₂ mode, and the signal energy in the LP₀₁ mode onto end face 57 of EDF′ 78 causing the light energy to propagate in EDF′ 78 in the desired modes.

While the above description has been described in a forward pumping direction, a reverse pumping embodiment, as shown in connection with FIG. 4a can be constructed by changing the placement of the fibers and the angle of the mirror.

FIG. 6b illustrates another embodiment of coupler 50′ combined with second mode converter 84 of FIG. 4a, wherein the dichroic filter 54 of FIG. 6a is replaced with a Faraday Rotator 65. In operation, the pump energy enters second mode converter 84 at input port 85 through single mode fiber 56, whose end face 57″ is cut at tie appropriate angle to prevent back reflection. The light energy is collimated by lens 52, and undergoes phase transformation in a manner as discussed above through phase elements 55 and optionally 55′. The light energy exiting the phase elements is in the shape of a single high order mode, in an exemplary embodiment the LP₀₂ mode and enters the faraday rotator 59 at port 60.

The faraday rotator 59 operates to transmit light energy entering at any port to exit at a port 90 degrees removed from the entry port. The light pump energy exits at port 62 and is focused by lens 52 into the end face 57′ of EDF′ 78. The light pump energy then propagates in EDF′ 78 exiting coupler 50′ through port 21. The optical signal traveling through EDF′ 78 absorbs the energy from the light pump traveling in the reverse direction, and exits EDF′ 78 at end face 57′ and is focused through lens 52 onto faraday rotator 59 at port 62. The amplified optical signal enters faraday rotator 59 at port 62 and exits at port 63, where it is focused by lens 52 into the end face 57 of fiber 65 which is designed to handle the high order mode of the signal.

FIG. 6c illustrates another embodiment of coupler 50″ combined with second and third mode converters 84 of FIG. 4a. In operation, the pump energy enters second mode converter 84 at input port 85 through single mode fiber 56, whose end face 57″ is cut at the appropriate angle to prevent back reflection. The light energy is collimated by lens 52, and undergoes phase transformation in a manner as discussed above through phase elements 55 and optionally 55′. The light energy exiting the phase elements is in the shape of a single high order mode, in an exemplary embodiment the LP₀₂ mode and enters the faraday rotator 59 at port 60.

The faraday rotator 59 operates to transmit light energy entering at any port to exit at a port 90 degrees removed from the entry port. The light pump energy exits at port 62 and is focused by lens 52 into the end face 57′ of EDF′ 78. The light pump energy then propagates in EDF′ 78 exiting coupler 50′ through port 21. The optical signal traveling through EDF′ 78 absorbs the energy from the light pump traveling in the reverse direction, and exits EDF′ 78 at end face 57′ and is focused through lens 52 onto faraday rotator 59 at port 62. The amplified optical signal enters faraday rotator 59 at port 62 and exits at port 63, where it is undergoes phase transformation through phase element 55 and optional phase element 55′ and is then focused by lens 52 into the end face 57 of fiber 51 which is a single mode fiber designed to handle the resultant fundamental or LP₀₁ mode. The signal exits the coupler 50″ at port 81 in the LP₀₁ mode.

FIG. 6d illustrates another embodiment of coupler 50 of FIG. 4b, using a polished fiber coupler, and consists of fiber 65 containing core 70 and cladding and jacket 71 connected at one end to output port 81 of first mode converter 84 and entering coupler 50 at port 51. Fiber 65′ containing core 70′ and cladding and jacket 71′ is connected at one end to output port 81 of first mode converter 84 and enters coupler 50 at port 24. Fiber 65 carries the signal in a single high order mode or in an alternative embodiment in the fundamental mode

Fiber 65′ is designed to have a propagation constant for the high order mode in the pump wavelength that closely matches the propagation constant in fiber 65 of the mode of the signal. Fiber 65 in one embodiment is a portion of EDF′ 78. The jacket and cladding of fiber 65′ is stripped down to the core 71′, and is placed in proximity to fiber 65 in a location where the jacket and cladding has been likewise stripped to the core 71. Light energy from fiber 65′ will be coupled into fiber 65 and will propagate in the high order mode in fiber 65 exiting the coupler 50 at port 23.

The above examples are not meant to be limiting in any way. Other mode transformers such as Bragg gratings may be utilized, other couplers may be utilized or the pump source may be designed to output a high order mode without exceeding the scope of the invention.

Having described the invention with regard to certain specific embodiments thereof, it is to be understood that the description is not meant as a limitation, since further modifications may now suggest themselves to those skilled in the art, and it is intended to cover such modifications as fall within the scope of the appended claims.

We claim:

1. A rare-earth doped fiber amplifier apparatus for amplifying an optical input signal having a first spatial mode, said apparatus comprising:
a light pump for generating light pump energy, said light pump energy having a second spatial mode; and
an optical fiber comprising a rare-earth dopant in optical communication with said light pump, said optical fiber supporting said first and second spatial mode,
wherein the optical input signal is amplified in said optical fiber by stimulated emission of said rare-earth dopant, in response to excitation by said light pump energy.

2. The apparatus of claim 1 further comprising an optical coupler having
a first input port for receiving said optical input signal having said first spatial anode,
a second input port in optical communication with said light pump having said second spatial mode, and
an output port,
wherein said optical coupler couples optical signals from said first and second input ports and outputs said coupled signals through said output port.

3. The apparatus of claim 2, wherein said coupler comprises a dichroic filter.

4. The apparatus of claim 2, wherein said coupler is a polished fiber coupler.

5. The apparatus of claim 2, wherein said coupler comprises a Faraday rotator.

6. The apparatus of claim 1 further comprising a first spatial mode transformer, wherein the optical input signal is converted from said first spatial mode to a third spatial mode.

7. The apparatus of claim 1 further comprising a second spatial mode transformer, wherein said light pump energy is converted to said second spatial mode.

8. The apparatus of claim 1 further comprising a third spatial mode converter, wherein said amplified optical signal is converted from said third spatial mode to said first spatial mode.

9. The apparatus of claim 1 wherein the rare-earth dopant comprises erbium.

10. The apparatus of claim 1 wherein said first spatial mode is the LP₀₁ spatial mode.

11. The apparatus of claim 1 wherein said second spatial mode is the LP₀₂ spatial mode.

12. The apparatus of claim 6 wherein said third spatial mode is the LP₀₂ spatial mode.

13. A method for amplifying an optical input signal having a first spatial mode comprising the steps of:
generating light pump energy having a second spatial mode; and
transferring said light pump energy having said second spatial mode to the optical input signal to generate an amplified optical signal.

14. The method of claim 13 further comprising the step of coupling said light pump energy to sand optical input signal prior to transferring said light pump energy having said second spatial mode to said optical input signal to generate said amplified optical signal.

15. The method of claim 13 further comprising the step of receiving said light pump energy and converting said light pump energy into said second spatial mode.

16. The method of claim 13 further comprising the step of receiving said optical input signal in said first spatial mode, and converting said optical input signal into a third spatial mode.

17. The method of claim 13 wherein said first spatial mode is the LP₀₁ spatial mode.

18. The method of claim 13 wherein said second spatial mode is the LP₀₂ spatial mode.

19. The method of claim 13 wherein said third spatial mode is the LP₀₂ spatial mode.

20. The method of claim 13 further comprising the step of reconverting said amplified signal to said first spatial mode.

21. An amplifying optical fiber comprising:
a core region doped with a rare-earth dopant; and
a cladding surrounding said core, said cladding comprising at least one refractive index step, wherein said amplifying optical fiber supports a high order spatial mode.

22. The apparatus of claim 21 wherein the rare-earth dopant comprises erbium.

23. The apparatus of claim 21 wherein the high order spatial mode is the LP₀₂ mode.

24. A coupler for coupling an optical signal and light pump energy, comprising at least one phase element and a dichroic filter or a Faraday rotator, wherein said signal and said light pump energy are of different wavelengths.
